(19) United States
(12) Patent Application Publication
(10) Pub. No.: US 2020/0369563 A1
(43) Pub. Date: Nov. 26, 2020

(54) SYSTEMS AND METHODS FOR FORMING OPTICAL FIBER COATINGS WITH REDUCED DEFECTS ON MOVING OPTICAL FIBERS

(71) Applicant: CORNING INCORPORATED, CORNING, NY (US)

(72) Inventors: Benjamin David Bayless, Wilmington, NC (US); Dana Craig Bookbinder, Corning, NY (US); Stephan Lvovich Logunov, Corning, NY (US); Darren Andrew Stainer, Wrightsville, NC (US); Ruchi Tandon, Painted Post, NY (US)

(21) Appl. No.: 16/872,750

(22) Filed: May 12, 2020

Related U.S. Application Data
(60) Provisional application No. 62/851,343, filed on May 22, 2019.

(51) Int. Cl. C03C 25/1065; C03C 25/105

(52) U.S. Cl. CPC C03C 25/1065; C03C 2218/111; C03C 2217/78; C03C 25/105

(57) ABSTRACT

The systems and methods of forming optical fiber coatings with reduced defects include moving a bare optical fiber through first and second coating sub-systems. The first coating sub-system forms a first coating on the bare optical fiber by depositing a first coating material and then curing the deposited first coating material with actinic light. This process also results in the formation of stray actinic light. The process also includes moving the coated optical fiber through a second coating sub-system to form a second coating on the first coating. A light-blocking device resides between the first and second coating sub-systems to block the stray actinic light. Without the light-blocking device, the stray actinic light can enter the second coating sub-system and reach the second coating material therein and form a gel therefrom, which in turn leads to defects in the coated optical fiber exiting the second coating sub-system.

This Application claims priority under 35 USC § 119(e) from U.S. Provisional Patent Application Ser. No. 62/851,343, filed on May 22, 2019, and which is incorporated by reference herein in its entirety.

### FIELD

The present disclosure relates to optical fibers, and in particular to systems and methods for forming optical fiber coatings with reduced defects on moving optical fibers.

### BACKGROUND

Optical fibers (“fibers”) are produced using an optical fiber drawing system. The drawing system heats an end of a glass fiber preform to the melt temperature, which causes the glass to form a thin strand. The thin strand is placed under tension to continuously draw the thin strand that constitutes a glass fiber based having a core and cladding configuration representative of the fiber preform, but at a greatly reduced scale.

A non-glass protective coating is added to the glass or “bare” fiber as it moves through the fiber drawing system to improve bend performance and damage resistance. A typical protective coating is made of an ultraviolet (UV) curable acrylate polymer. In some cases, multiple coatings are used, with the coatings having different elastic moduli. The protective coatings are deposited onto the fiber by passing the bare fiber through a series of coating dies that deposit the coating material onto the outer surface of the bare fiber. The deposited coating materials are cured using actinic light that irradiates the coated fiber as it moves to the next coating die or to the take-up spool of the fiber drawing system.

The process of adding one or more protective coatings to the moving bare fiber can result in defects. The defects can be in the form of voids within the coating layer or between adjacent coating layers. The coating defects can adversely affect the optical performance of the fiber. In addition, the coating dies can flood, which requires stopping the drawing process to clean or replace the flooded coating die. Each of these problems reduces manufacturing efficiency and results in increased fiber costs. Moreover, each of these problems has been long-standing issues in the art of optical fiber manufacturing with a long-felt need for a solution. Unfortunately, the root cause behind these issues to date has been difficult to identify.

### SUMMARY

The systems and methods disclosed herein are a result of intensive investigation and experimentation to determine the root cause of the formation of defects when coating a moving optical fiber. In particular, the systems and methods disclosed herein are generally directed to preventing stray actinic light used to cure the coating material in one coating layer formed using one coating sub-system from inadvertently reaching and at least partially curing (e.g., gelling) the coating material used in a downstream coating sub-system.

The systems and methods of forming optical fiber coatings include moving a bare optical fiber through first and second coating sub-systems. The first coating sub-system forms a first coating on the moving bare optical fiber by depositing a first coating material and then curing the deposited first coating material with actinic light. This process also results in the formation of stray actinic light. The process also includes passing (moving) the optical fiber with the cured first coating material through a second coating sub-system to form a second coating on the first coating. A light-blocking device resides between the first and second coating sub-systems to block the stray actinic light from entering the second coating sub-system and in particular from entering the coating die therein. This is because the stray actinic light can enter the coating die and irradiate second coating material therein, resulting in the formation a gel on or within the coating die of the second coating sub-system. The gel in turn can lead to the formation defects (e.g., voids) in the coated optical fiber exiting the second coating sub-system. Such defects can adversely impact the performance of the optical fiber. In addition, the formation of the gel can cause die flooding, which requires idling the fiber draw process to clean or replace the coating die.

An embodiment of the disclosure is directed to a coating system for coating a moving optical fiber, comprising: a first coating sub-system, the first coating sub-system configured to apply a first coating material to a moving optical fiber, the first coating sub-system comprising a source of actinic light configured to generate actinic light for curing the first coating material to form a first coating on the moving optical fiber, the source of actinic light further generating stray actinic light, the stray actinic light exiting the first coating sub-system; a second coating sub-system containing a second coating material, the second coating sub-system configured to receive the moving optical fiber and to apply the second coating material to the first coating; and a light-blocking device operably disposed between the first and second coating sub-systems, the light-blocking device configured to receive the moving optical fiber, the light-blocking device further configured to receive the stray actinic light exiting the first coating sub-system and to direct the stray actinic light to the second coating sub-system, the stray actinic light entering the light-blocking device at a first intensity, the first intensity sufficient to cause formation of a gel from the second coating material in the second coating sub-system within a first time period, the light-blocking device attenuating the stray actinic light such that (i) none of the stray actinic light is incident to the second coating sub-system or (ii) the stray actinic light exiting the light-blocking device is incident to the second coating sub-system at a second intensity, the second intensity insufficient to cause formation of a gel from the second coating material in the second coating sub-system within a second time period, the second time period being at least a factor of two longer than the first time period.

Another embodiment of the disclosure is directed to method for coating a moving optical fiber, comprising: directing a moving optical fiber into a first coating sub-system; applying a first coating material to the moving optical fiber in the first coating sub-system; curing the first coating material to form a first coating on the moving optical fiber; the curing comprising directing actinic light from a source of actinic light to the first coating material, the actinic light comprising actinic light for curing the first coating material and stray actinic light, the stray actinic light having an intensity, the stray actinic light exiting the first coating sub-system at a first intensity and propagating toward a second coating sub-system, the second coating sub-system containing a second coating material, the first intensity sufficient to cause formation of a gel from the second coating material in the second coating sub-system in a first time period; reducing the intensity of the stray actinic light from the first intensity such that (i) none of the stray actinic light is incident to the second coating sub-system or (ii) the stray light is incident to the second coating sub-system at a second intensity, the second intensity insufficient to cause formation of a gel from the second coating material in the second coating sub-system in a second time period, the second time period being at least a factor of two longer than the first time period; directing the moving optical fiber from the first coating sub-system to the second coating sub-system; and applying the second coating material to the first coating in the second coating sub-system.

Additional features and advantages are set forth in the Detailed Description that follows, and in part will be apparent to those skilled in the art from the description or recognized by practicing the embodiments as described in the written description and claims hereof, as well as the appended drawings. It is to be understood that both the foregoing general description and the following Detailed Description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the Detailed Description explain the principles and operation of the various embodiments. As such, the disclosure will become more fully understood from the following Detailed Description, taken in conjunction with the accompanying Figures.

FIG. 1 is a schematic diagram of an example optical fiber drawing system used to fabricate a coated optical fiber, wherein the system has a bare-fiber-forming section, a coating section and a take-up section.

FIG. 2 is a schematic diagram of an example of the coating system that constitutes the coating section of the optical fiber drawing system of FIG. 1.

FIG. 3A is a close-up view of an example coating die of the second coating sub-system, along with the actinic light source system of the first coating sub-system that resides immediately upstream therefrom.

FIG. 3B is a close-up view of the guide member and sizing member of the coating die, illustrating the formation of a gel caused by stray actinic light traveling through the central channel of the coating die and reaching the coating material.

FIG. 4 is a schematic diagram of an example coating system 200 that includes the actinic light source system 250 of the first coating sub-system 200A and the coating die 210 of the second coating sub-system 200B with a light-blocking device 300 operably disposed between.

FIG. 5A is similar to FIG. 4 and shows an example light-blocking device disposed between the actinic light source of the first coating sub-system and the coating die of the second coating sub-system.

FIG. 5B is similar to FIG. 5A and shows another example of the light-blocking device.

FIG. 6A is an elevated and partially cut-away view of an example light-blocking device in the form of a light baffle.

FIG. 6B is a cross-sectional view of the light-blocking device of FIG. 6A, with the close-up inset showing example micro-features that can be used to block stray actinic light.

FIGS. 7A and 7B are elevated and cross-sectional views, respectively, of another example light-blocking device.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

The abreviation “sec” stands for “second” or “seconds.”

The letter “W” stands for “Watt” or “Watts.” The symbol “μW” stands for “micro-Watt” or “micro-Watts.”

Cartesian coordinates are used in some of the Figures for the sake of reference and ease of explanation and are not intended to be limiting as to direction or orientation.

Any relative terms like top, bottom, side, horizontal, vertical, etc., are used for convenience and ease of explanation and are not intended to be limiting as to direction or orientation.

The terms “upstream” and “downstream” are used as relative terms to indicate relative positions of items (e.g., items A and B) relative to the direction of movement of the optical fiber being coated, wherein the phrase A upstream (downstream) of B means that item A comes before (after) item B. For example, a draw furnace used to melt a glass fiber preform is upstream of a coating system, which is upstream of a take-up spool. Conversely, a take-up spool is downstream of a coating system, which is downstream of a draw furnace. Similarly, a bare fiber is upstream of a coated fiber.

In the discussion below, stray actinic light is any actinic light from an actinic light source system that travels beyond the curing zone (defined below).

The acronym “UV” stands for “ultraviolet.” In an example, the actinic light and stray actinic light comprises UV light. UV light refers to light having a wavelength between 100 nm and 400 nm.

The term “optical fiber” refers to a glass waveguide having a glass core surrounded by a glass cladding, where the refractive index of the glass core is greater than the refractive index of the glass cladding. Optical fibers include bare optical fibers and coated optical fibers.

A “bare optical fiber” or “bare fiber” is an optical fiber without a coating.

A “coated optical fiber” or “coated fiber” is an optical fiber having one or more coatings.

The term “coating” refers to a non-glass material that surrounds and is in direct or indirect contact with the glass cladding of an optical fiber. Preferred non-glass materials are organic materials, including polymers and plastics. Coatings are formed by applying a coating material to a bare fiber or a coated fiber. Preferred coating materials are radiation-curable materials that are applied as viscous liquids and cured to a rigid state. The term “coating” includes a coating material that has not been cured, a coating material in the process of being cured or a coating material that has been cured. The particular state of the coating (uncured, partially cured or cured) will be apparent from the context of the discussion.

The term “gel” refers to a coating material that has a higher viscosity than the uncured coating material. For purposes of the present disclosure, gel refers to a partially cured coating material having a degree of cure of at least 10%, where degree of cure refers to the fraction of reacted acrylate bonds in the coating material. The degree of cure of an uncured coating material is 0%, which means that none of the acrylate bonds in the coating material has reacted. The degree of cure of a fully cured coating material is 100%, which means that all acrylate bonds in the coating material have reacted in the curing reaction. A gel represents an intermediate state of reaction between the uncured and fully cured states of the coating material. As the degree of cure increases, the viscosity of a gel increases and the presence of a gel becomes more problematic to the fiber drawing and coating processes. Prevention of gel formation by reducing exposure of the coating material to stray actinic light (referred to herein as “blocking”) includes both the concept of precluding gel formation regardless of the exposure time and the concept of preventing gel formation at the same speed that occurs without reducing exposure of the coating material to the stray actinic light. Thus, in an example, gel prevention includes providing a substantial delay in the formation of the gel, i.e., that the formation of a gel will not occur within a time period that is long compared to the time period for gel formation when there is no blocking of the stray actinic light. Under otherwise common conditions, the time period for gel formation when blocking stray actinic light as described herein is at least a factor of two, or a factor of five, or a factor of 10, or a factor of 100, or a factor of 1000 longer than the time period for gel formation without blocking stray actinic light as described herein. The term “factor of X” (where X is 2, 5, etc.) means X times as long. For example, the time periods 4 sec, 10 sec, 20 sec, 200 sec, and 2000 sec are factors of X of 2, 5, 10, 100, and 1000, respectively, longer than a time period of 2 sec.

Fabricating a Coated Optical Fiber

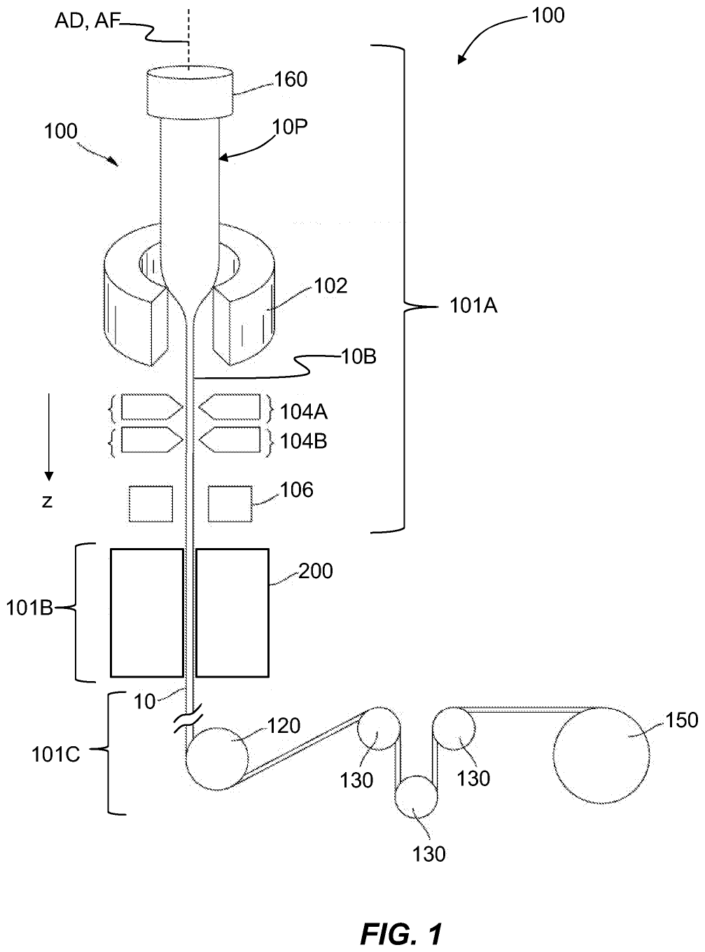

FIG. 1 is a schematic diagram of an example optical fiber drawing system (“drawing system”) 100 used to fabricate a coated optical fiber 10. The drawing system 100 comprises three main sections: a bare-fiber-forming (“bare fiber”) section 101A, a coating section 101B downstream of the bare fiber section 101A, and a take-up section 101C downstream of the coating section 101B.

An example bare fiber section 101A of the drawing system 100 comprises a draw furnace 102 for heating an end of an optical fiber preform 10P to its glass melt temperature (e.g., to about 2000° C.). The drawing system 100 includes other components such as non-contact measurement sensors 104A and 104B for measuring the size of the bare fiber 10B upon drawing as it exits the draw furnace 102 for size (diameter) control, and a cooling station 106 to cool the bare fiber 10B. The drawing system 100 also includes a preform holder 160 located adjacent the top side of the draw furnace 102 and that holds the preform 10P used to form the bare fiber 10B and the coated fiber 10.

The coating section 101B comprises a coating system 200 that coats the bare fiber 10B with one or more coatings (as described in more detail below) to form a coated fiber 10.

The take-up section 101C comprises a tensioner 120 to pull (draw) the bare fiber 10B and coated fiber 10, guide wheels 130 to guide the drawn fiber, and a fiber take-up spool (“spool”) 150 to store the drawn and now coated fiber 10.

In forming the coated fiber 10, the fiber preform 10P is heated at one end by the draw furnace 102 to form bare fiber 10B, which exits the draw furnace 102 and travels along a draw axis AD. The bare fiber 10B also has a fiber axis AF that is coaxial with the draw axis AD. The tensioner 120 applies tension along the length of the bare fiber 10B, i.e., in the z-direction to continue drawing the bare fiber 10B from the preform 10P. The dimensions (e.g., the diameter) of the bare fiber 10B are measured by the non-contact sensors 104A and 104B and the measured dimensions are used to control the draw process. The bare fiber 10B can then pass through the cooling mechanism 106, which can be filled with a gas that facilitates cooling at a controlled rate slower than air at ambient temperatures. The coating system 200 then applies one or more coatings to the bare fiber 10B to form the coated fiber 10.

The coated fiber 10 passes from the tensioner 120 to the guide wheels 130, then through the guide wheels to the spool 150, where the coated fiber is taken up and stored. The configuration of the coated fiber and the various drawing parameters (draw speed, temperature, tension, cooling rate, etc.) dictate the final form of the coated fiber 10.

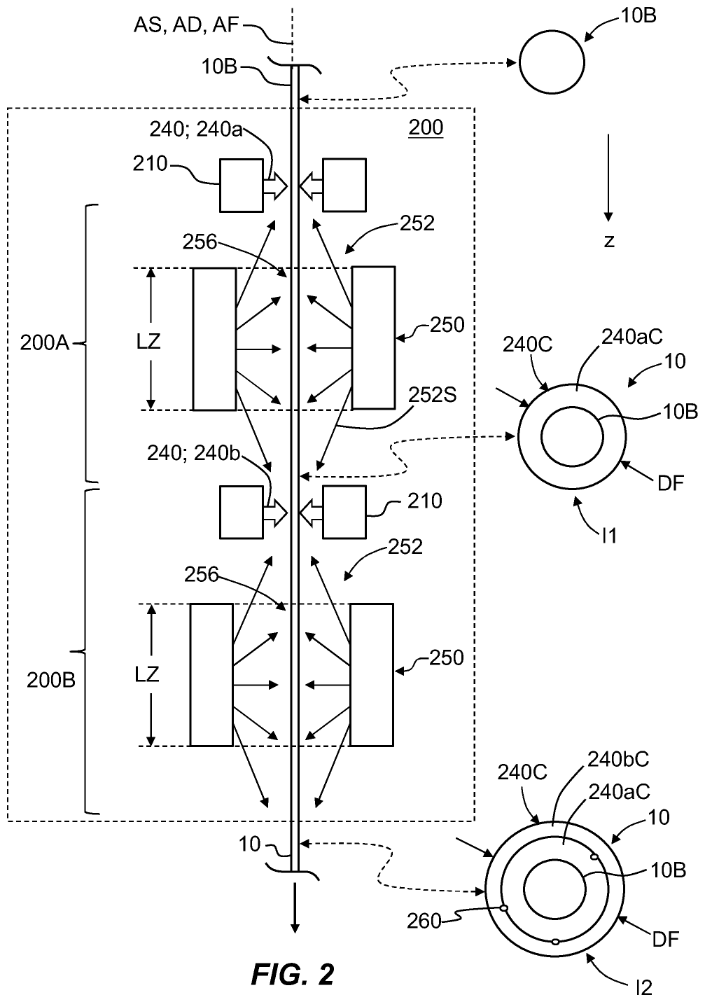

FIG. 2 is a schematic diagram of an example of the coating system 200. The coating system 200 can be incorporated into the drawing system 100 as shown or can be an off-line drawing system. The coating system 200 includes a system axis AS. The coating system also includes by way of example and in order along the system axis AS in the z-direction: a first or primary coating die 210, a first or primary actinic light source system 250, a second or secondary coating die 210 and a second or secondary actinic light source system 250. Each actinic light source system 250 emits actinic light (radiation) 252. An example actinic light source system 250 comprises multiple actinic light sources arranged to irradiate the coated fiber 10 substantially equally around its circumference. An example actinic light source includes one or more actinic light emitters (e.g., UV lamps or UV LEDs) with one or more reflectors configured to redirect actinic light toward the fiber 10 from all directions. An example actinic light source 250 comprises five UV lamps.

The primary coating die 210 and primary actinic light source system 250 constitutes a first or primary coating system sub-system 200A while the second (secondary) coating die 210 and the second (secondary) actinic light source system 250 constitute a second or secondary coating sub-system 200B.

Each coating die 210 deposits a layer of coating material 240 onto the bare fiber 10B (or onto an upstream coating applied to the bare fiber 10B), wherein the coating material is irradiated and cured by the actinic light 252 as the coated fiber travels through the coating system 200 along the system axis AS. In an example, the actinic light 252 comprises or consists of UV light. The combination of bare fiber 10B and at least one layer of coating material 240 constitutes a coated fiber 10. The coated fiber 10 has a diameter DF.

The first or most upstream coating die 210 of the first coating sub-system 200A deposits a first coating material 240 (denoted 240a), while the second or downstream coating die 210 of the second coating sub-system 200B deposits a second coating material 240 (denoted 240b) different from the first coating material. Additional pairs of coating dies 210 and actinic light sources 250 in downstream coating sub-systems (not shown) can also be included and only two coating sub-systems are shown by way of example. In one example, the first and second coating materials 240a and 240b comprise different acrylate materials having different moduli of elasticity when cured. By way of example, a third coating sub-system with a third coating die (not shown) can deposit an ink used for marking the coated fiber 10, e.g., to define indicia for identification purposes.

The actinic light 252 from each actinic light source system 250 irradiates the deposited coating material 240 over a curing zone 256 having an axial length LZ. The curing zone 256 of length LZ is used to ensure the newly deposited coating material 240 receives a proper dose D of the actinic light 252 as the coated fiber 10 moves in the z-direction at a fiber draw speed S. A typical draw speed can be in the range from 5 meters/second (m/s) to in excess of 40 m/s (e.g. 50 m/s or 60 m/s or higher).

The intensity I of the actinic light 252 at the surface of the coating material 240 multiplied by the exposure time defines the dose D, i.e., D=I·t_{E} received by the newly deposited coating material 240 as the coated fiber 10 moves through the curing zone. The intensity I and exposure time t_{E} are selected so that the dose D is sufficient to cure the coating material 240 at a given location of the coated fiber 10 prior to the coated fiber entering a downstream coating sub-system (e.g., coating sub-system 200B) or prior to being wound on the spool 150. The exposure time t_{E} of a given point of the coated fiber 10 is defined by the intensity I of the actinic light 252, the axial length LZ of the curing zone 256 and the fiber draw speed S through the curing zone 256. An example intensity I of UV actinic light 252 for curing a polymer acrylate coating material is about 15 W/cm² or greater. An example axial length LZ of the curing zone 256 is about 1 m and an example fiber draw speed is 10 m/s to 50 m/s.

The cured coating material 240 defines a (cured) coating 240C. The first close-up inset I1 in FIG. 2 shows the coated fiber 10 with the first coating 240aC while the second close-up inset shows the coated fiber with a first and second coatings 240aC and 240bC. The cured coating, whether comprising a single coating or multiple coatings, is denoted 240C.

As noted above, and as shown in the close-up inset 12 of FIG. 2, defects 260 can form in the cured coating 240C. In an example, the defects 260 take the form of voids between the first and second (primary and secondary) coatings 240aC and 240bC. In some cases, these void defects 260 are also associated with “abrasions” or roughening of the primary coating 240aC that act as nucleating sites for the formation of the voids. There can also be voids between the secondary coating 240bC and a tertiary (ink) coating (not shown), and also between the ink coating and the ribbon matrix (not shown) in a ribbon stack of optical fibers.

These void defects 260 can impact fiber performance and thus cause lower fiber yields and higher manufacturing costs, as well as limit or make it difficult in start-up and operation of an optical fiber draw. In addition, as mentioned above, die floods can occur in coating dies that reside immediately downstream of an actinic light source system 250. When a die flood occurs, the fiber drawing process must be idled to clean and/or replace the die and this delay contributes to manufacturing costs because it reduces fiber throughput through the drawing system 100.

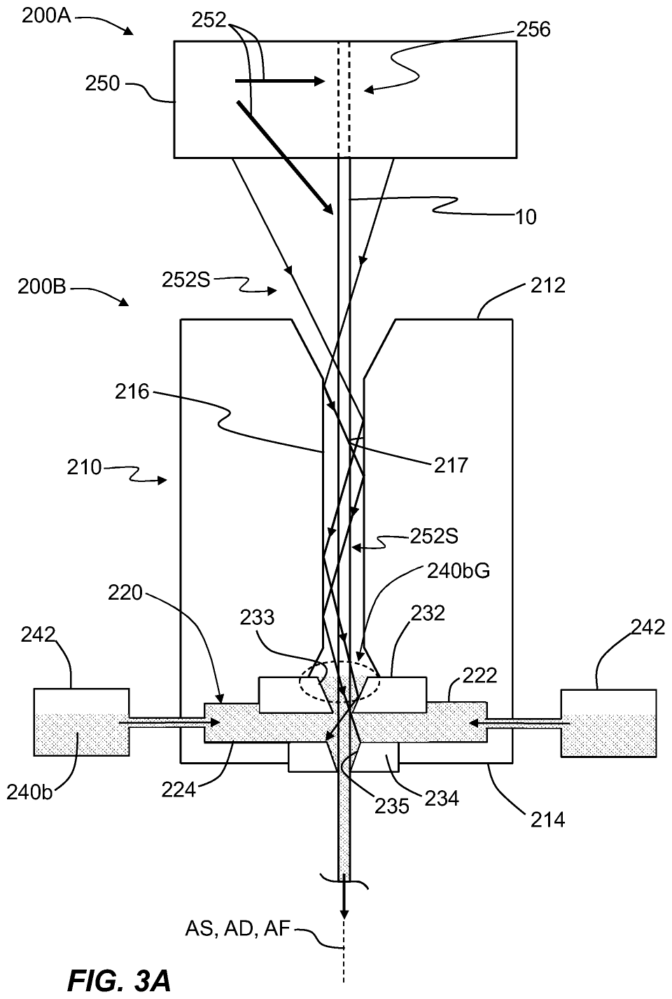

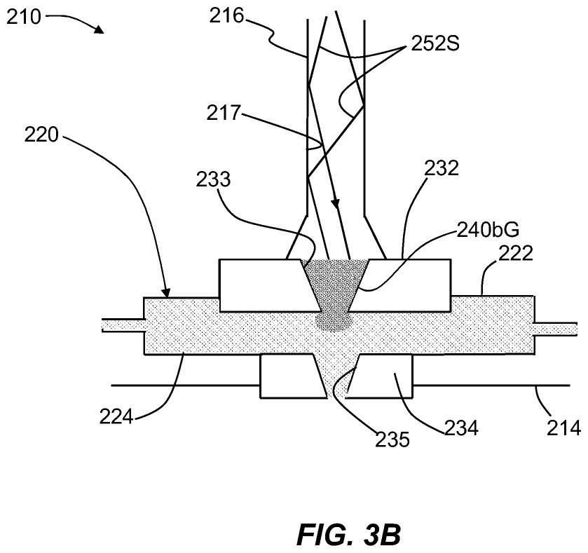

FIG. 3A is a close-up view of an example coating die 210 of the second coating sub-system 200B, along with the actinic light source system 250 of the upstream first coating sub-system 200A. The coating die 210 has an input end 212 through which the coated fiber 10 enters the die and an output end 214 where the coated fiber 10 exits the die with the second coating material 240b deposited thereon. The coating die 210 includes a central channel 216 through which the coated fiber 10 passes from the input end 212 to the output end 214.

The coating die 210 also includes an internal chamber 220 that holds the coating material 240 (here, coating material 240b) and through which the central channel 216 passes. The internal chamber 220 includes input end 222 and an output end 224 and holds the coating material 240b, which is provided to the internal chamber from a coating material supply 242. A guide member 232 resides at the input end 222 where the central channel 216 enters the internal chamber 220. The guide member 232 has an angled aperture 233 sized to guide the coated fiber into the internal chamber 220.

A sizing member 234 resides at the output end 224 of the internal chamber 220 and at the output end 214 of the coating die. The sizing member 224 has an aperture 235 sized to define the size (thickness) of the second (secondary) coating material 240b deposited onto the coated fiber 10 as the coated fiber (having the first coating 240aC) passes through the coating material 240b held in the internal chamber 218. Some of the coating material 240b can reside within the angled aperture 233 of the guide member 232. FIG. 3B is a close-up view of the output end 214 of the coating die 210, the internal chamber 220, the guide member 232 and the sizing member 234.

As noted above and as shown in FIG. 2, the actinic light source system 250 irradiates the coating material 240a on the bare fiber 10B with actinic radiation 252 over the curing zone 256 to form the primary coating 240aC of the coated fiber 10. However, some of the actinic light 252 can travel from the actinic light source system 250 beyond the curing zone 256 and into a downstream coating die 210 as shown in FIG. 3A. This actinic light is referred to as stray actinic light and is denoted 252S. Some of the stray actinic light 252S can travel down the central channel 216 the coating die 210 and irradiate the coating material 240b that resides within the angled aperture 233 of the guide member 232. As the coating die 210 is typically formed from metal such as stainless steel, the stray light 252S can reflect from the interior wall 217 of the central channel 216, which can act a light guide for the stray actinic light, thereby exacerbating the unintentional stray actinic light irradiation of the coating material 240b.

With reference again to FIGS. 3A and 3B, it has been found that this unintentional irradiation of the coating material 240b within the coating die 210 by the stray actinic light 252S can cause a portion of the coating material 240b residing within the guide member 232 to cure (i.e., partially cure, such as for example 20% to 30% cure) and form a gelled coating material (“gel”) 240bG. The formation of gel 240bG can extend into the internal camber 220 and cause the coating die 210 to flood by inhibiting the flow of the coating material 240b through the internal chamber 220. The gel 240bG can also find its way into or onto the fiber coating 240C to form a coating defect 260.

The stray light 252S can have an intensity substantially less than that used in irradiating the coating material 240a in the curing zone 256. In one example experiment where the intensity of the actinic light 252 in the curing zone was about 15 W/cm², the stray actinic light 252S that caused the formation of gel 240bG from coating material 240b within the coating die 210 was measured to be as low as 15 μW/cm² (15 microwatts/cm²), i.e., about 10⁶ times less intense than the exposure light for curing the coating material 240a. Further, it was found that exposure of the coating material 240b at these low power levels for about 75 minutes resulted in the formation of the gel 240bG within the coating die 210. In another experiment, it was found that exposure to stray light 252S having an intensity of 500 μW/cm² resulted in the formation of gel 250bG in only 2 seconds.

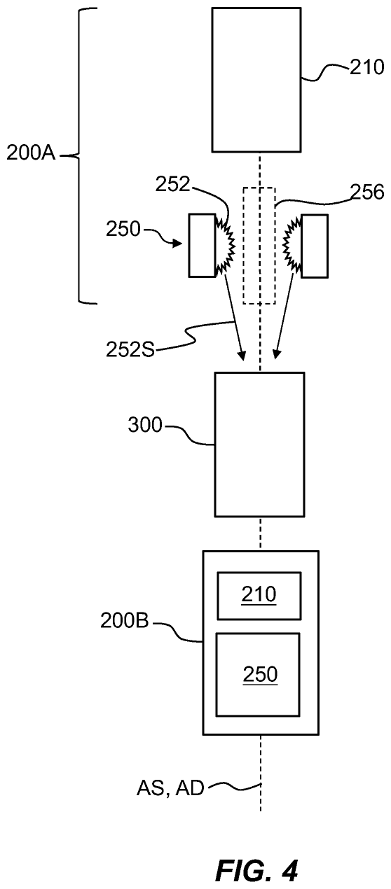

FIG. 4 is a schematic diagram of an example coating system 200 that includes the actinic light source system 250 of the first coating sub-system 200A and the second coating sub-system 200B with a light-blocking device 300 operably disposed between. The light-blocking device 300 is configured to block stray actinic light 252S from entering the coating die 210 of the second coating sub-system 200B. Preferably, “block” or “blocking” means reducing the intensity of the stray actinic light 252S to a level such that the intensity of the stray actinic light 252S incident to the second coating sub-system 200B, the coating die 210 of the second coating sub-system 200B, the guide member 232 of the second coating sub-system 200B, or the surface of incidence of the stray actinic light 252S with coating material 240b within the second coating sub-system 200B is insufficient to cause formation of the gel 240bG from the coating material 240b within 10 minutes, or within 30 minutes, or within 60 minutes, or within 90 minutes, or within 150 minutes, or within 200 minutes or within 500 minutes or within 1000 minutes or within 2 days or within a week. In other examples, gel prevention means that the time period for gel formation when blocking stray actinic light is at least a factor of two, or a factor of three, or a factor of five, or a factor of 10, or a factor of 20, or a factor of 50, or a factor of 100, or a factor of 1000 longer than the time period for gel formation without blocking stray actinic light. The term “factor of X” (where X is 2, 5, etc.) means X times as long.

In various examples, the amount of stray actinic light 252S entering the central channel 216 at the input end 212 of the coating die 210 of the second coating sub-system 200B is reduced by the light-blocking device 300 to be less than 60 μW/cm², or less than 40 μW/cm², or less than 20 μW/cm², or less than 10 μW/cm², or less than 5 μW/cm², or less than 2 μW/cm², or less than 0.20 μW/cm², or less than 0.02 μW/cm², or in the range from 0.01 μW/cm² to 60 μW/cm², or in the range from 0.05 μW/cm² to 40 μW/cm², or in the range from 0.10 μW/cm² to or 20 μW/cm². In an example, the blocking using the light-blocking device 300 increases the amount of time of formation of the gel 240bG by at least a factor of two, or a factor of three, or a factor of five, or a factor of 10, or a factor of 20, or a factor of 50, or a factor of 100, or a factor of 1000

In another aspect, the light-blocking device receives stray light at an incident intensity and directs a reduced intensity of the stray light to the second coating sub-system. In some embodiments, the intensity of stray light incident to the second coating sub-system is less than 50% or less than 25%, or less than 10%, or less than 5%, or less than 1% of the intensity of stray light incident to the light blocking device. In other embodiments, the intensity of stray light incident to the coating die of the second coating sub-system is less than 50% or less than 25%, or less than 10%, or less than 5%, or less than 1% of the intensity of stray light incident to the light blocking device. In some embodiments, the intensity of stray light incident to the guide member of the second coating sub-system is less than 50% or less than 25%, or less than 10%, or less than 5%, or less than 1% of the intensity of stray light incident to the light blocking device. In some embodiments, the intensity of stray light incident to the surface of incidence of the stray actinic light with the coating material within coating die of the second coating sub-system is less than 50% or less than 25%, or less than 10%, or less than 5%, or less than 1% of the intensity of stray light incident to the light blocking device.

In some embodiments, the intensity of stray light incident to the light blocking device is greater than 60 μW/cm², or greater than 75 μW/cm², or greater than 90 μW/cm², or greater than 120 μW/cm².

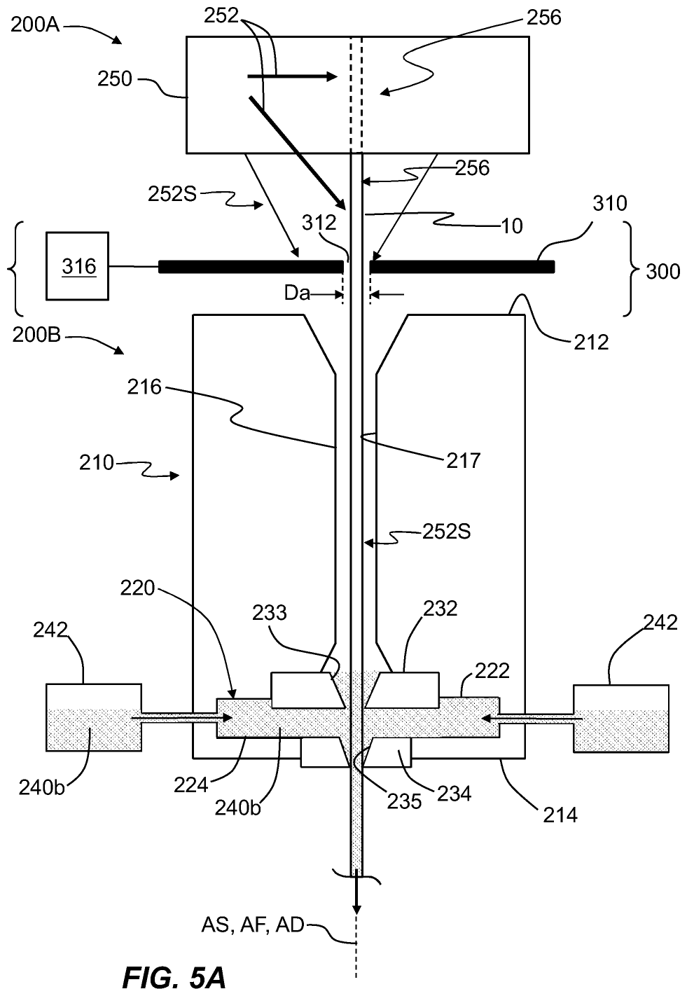

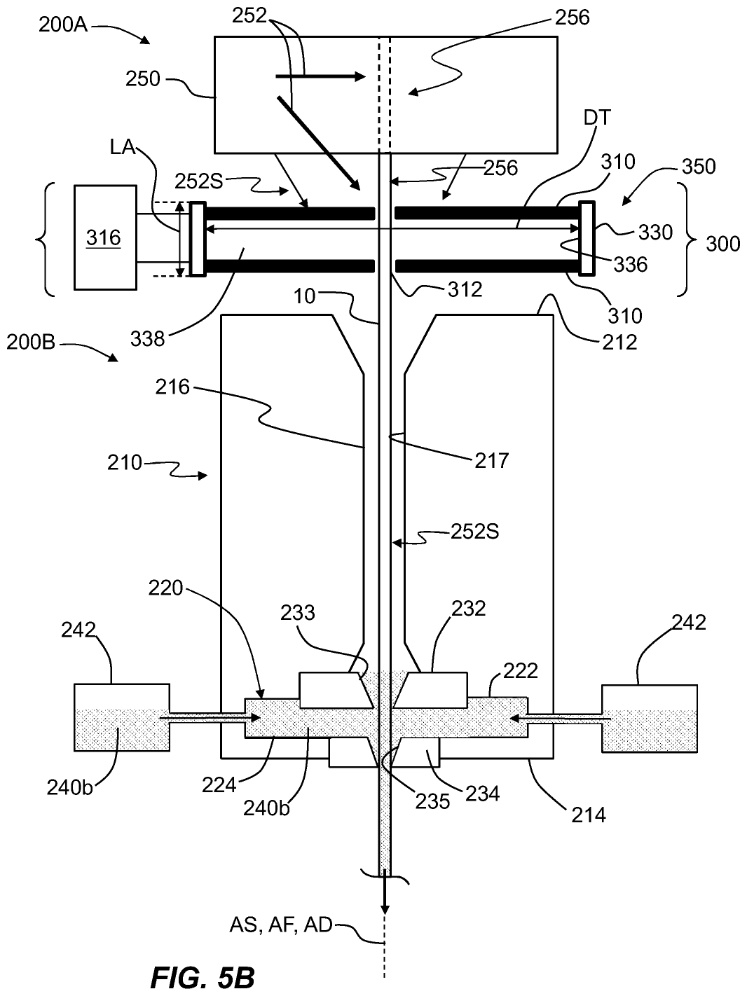

FIG. 5A is similar to FIG. 3A and additionally includes an example light-blocking device 300 operably disposed along the system axis AS between the primary and secondary sub-systems 200A and 200B, namely between the actinic light source system 250 of the primary sub-system 200A and the coating die 210 of the secondary sub-system 200B. The example light-blocking device 300 comprises an iris 310 having a central aperture 312 centered on the system axis AS. In an example, the size (diameter) of the central aperture is adjustable, e.g., either manually or by operation of an iris controller 316.

The size of the central aperture 312 is selected to pass the coated fiber 10 while substantially preventing stray actinic light 252S from entering the central channel 216 at the input end 212 of the coating die 210 of the coating sub-system 200B. An example range on the diameter Da of the central aperture 312 is 0.5 mm to 50 mm, or 0.5 mm to 25 mm, or 0.5 mm to 15 mm, or 0.8 mm to 10 mm. In another example, for a given diameter DF of the coated fiber 10, the central aperture diameter Da is in the range (1.05)·DF≤Da≤(10)·DF or in the range (1.5)·DF≤Da≤(5)·DF. In an example, the central aperture diameter Da is sized as small as possible to pass the coated fiber 10 without touching the coated fiber 10, accounting for lateral displacements of the coated fiber 10 that can occur for example due to vibrations caused by the coated fiber 10 moving at a drawing speed S through the fiber drawing system 100. In an example, the bare fiber 10B has a diameter of about 0.125 mm while the coated fiber 10 with the primary coating 240aC has a diameter DF of about 0.165 mm.

FIG. 5B is similar to FIG. 5A and shows an example light-blocking device 300 with two axially spaced-apart irises 310. In an example, the spaced-apart irises 310 can be supported by a tube 330 having an axial length LA, an inside diameter DT, and interior surface 336 that defines a tube interior 338. The combination of the spaced-apart irises 310 and the tube 330 constitute an example of a light baffle 350. In an example, the interior surface 336 of the tube 330 can be roughened or include light-absorbing material (e.g., light-absorbing paint, lamp black, etc.) to reduce specular reflection of stray actinic light from the interior surface. In an example, the upstream iris 310 can reside immediately adjacent the curing zone 256 while the downstream iris 310 can reside immediately adjacent the input end of the coating die 210. In addition, more irises 310 can be employed beyond the two irises 310 shown by way of example in FIG. 5B.

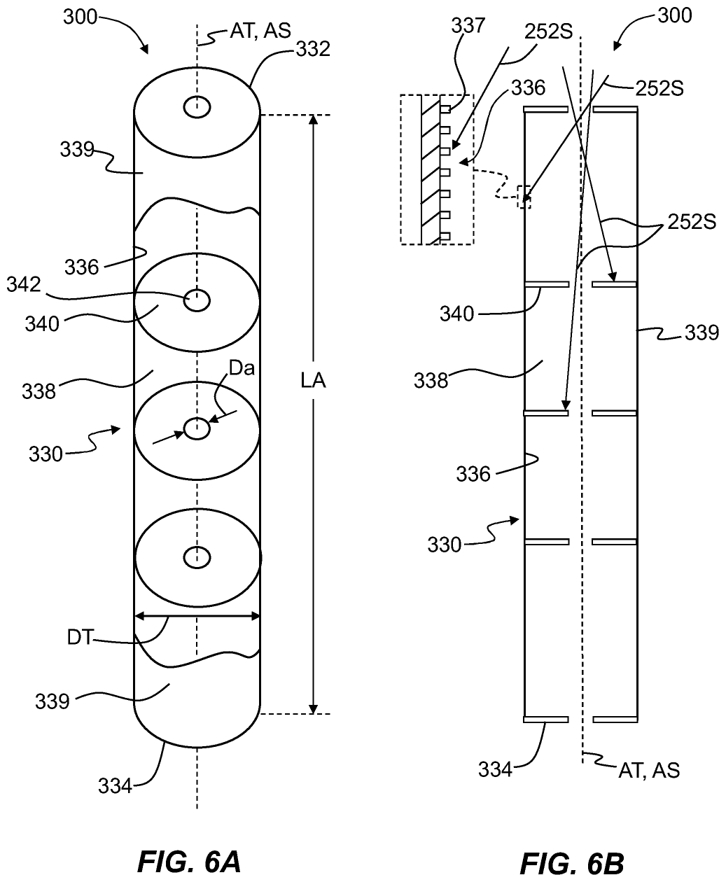

FIG. 6A is an elevated and partially cut-away view of an example light-blocking device 300 in the form of a light baffle similar to that of FIG. 5B. FIG. 6B is a cross-sectional view of the example light-blocking device 300 of FIG. 6A. The light-blocking device 300 of FIG. 6A includes the tube 330 with a tube axis AT and opposite first and second ends 332 and 334 and an exterior surface 339. The light-blocking device 300 has two or more fixed or adjustable aperture members 340 operably supported in the tube interior 338 and having central apertures 342. In an example, the adjustable aperture members 340 can comprise the aforementioned irises 310. Example light-blocking devices 300 comprise between two and ten spaced apart aperture members 340.

The central apertures 342 are substantially aligned along the tube axis AT, which in turn is substantially aligned with the coating system axis AS. The apertures 342 are sized to pass a coated optical fiber 10 while substantially preventing stray light 252S entering the first end 332 from passing through out of the second end 334. In an example, the diameter Da of the apertures 342 can be in the range from 0.5 mm to 50 mm, or 0.5 mm to 25 mm, or 0.5 mm to 15mm, or 0.8 mm to 10 mm. In an example, for the coated fiber 10 of diameter DF (with just the primary coating 240aC), the diameter Da of the apertures 342 can be in the range (1.05)·DF≤Da≤(10)·DF or in the range (1.5)·DF≤Da≤(5)·DF. In an example, the aperture diameter Da is sized as small as possible to pass the coated fiber 10 without touching the coated fiber 10, accounting for lateral displacements of the coated fiber 10 due to vibrations caused by the coated fiber 10 moving at a fast speed (e.g., at the drawing speed S) through the coating system 200 during the coating process. In an example, the bare fiber 10B has a diameter of about 0.125 mm while the coated fiber 10 with the primary coating 240aC has a diameter DF of about 0.165 mm. The diameter Da of the apertures 342 need not all be the same size. In one example light-blocking device 300 having four spaced-apart aperture members 340, two of apertures 342 had diameters Da of 5 mm and two of the apertures had diameters Da of 10 mm, with LA=15 inches, with the interior surface 336 of the tube 300 having threads (which can be considered an example of the micro-structure elements 337 introduced and discussed below).

In an example, the aperture members 340 comprise a material that is opaque to the wavelength of the actinic light 252. In another example, the aperture members 340 comprise glass, metal, or ceramic substrate having an optical surface configured to block the wavelength of the actinic light 252.

As noted above, the interior surface 336 of the tube 330 can comprise one or more light-scattering or light-absorbing features. The close-up inset of FIG. 6B shows an example where the interior surface 336 includes microstructure elements 337 configured to reduce the transmission of stray actinic light 252S through the light-blocking device 300. In an example, the microstructure elements 337 can be micro-rings that run around the circumference of the interior surface 336. In an example, the micro-rings can comprise threads (e.g., “spiral micro-rings”) as mentioned above. In another example, the micro-structure elements can be an array of micro-pillars that reduce the amount of specular reflection of stray actinic light from the interior surface 336 as compared to a smooth interior surface 336. As mentioned above, the interior surface 336 can comprise a material that substantially absorbs the stray actinic light 252, such as light-absorbing paint, lamp black, etc.

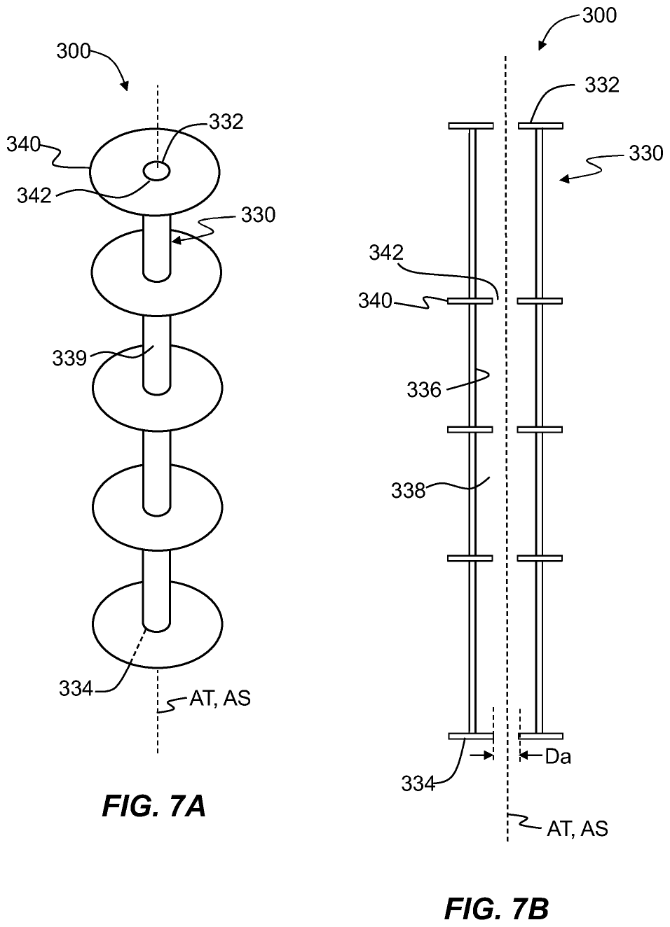

FIGS. 7A and 7B are similar to FIGS. 6A and 6B and illustrate another embodiment of the light-blocking device 300 wherein the tube 300 has a relatively small diameter and wherein the blocking aperture members 340 extend past the exterior surface 339. Access to the blocking aperture members 340 can allow the size of the apertures 342 to be adjusted (e.g., the blocking aperture members 340 can comprise irises 310).

In an example, the light-blocking device 300 blocks at least 99% of the stray light 252S that would otherwise reach the input end 212 of the coating die 210. In other examples, the light-blocking device 300 blocks at least 99.5% of the stray actinic light 252S or at least 99.9% of the stray actinic light or at least 99.95% of the stray actinic light.

An example axial length LA of the light-blocking device 300 is in the range from 1 cm to 250 cm while an example inside tube diameter DT of the tube 300 is in the range from 0.5 mm to 20 mm. An example number of aperture members 340 is between two and ten. Example ranges on the aperture diameter Da of the aperture members 340 are set forth above. Example moduli of elasticity Eₐ and E_{b} for the primary and secondary coatings 250aC and 240bC are Eₐ<1.5 Megapascals (MPa) at room temperature and E_{b}>1000 MPa or E_{b}>1500 MPa or E_{b}>2000 MPa at room temperature. Experiments were carried out in an attempt to create the gel 240bG in the coating die using thermal means and these experiments were not successful. On the other hand, experiments on the coating die 210 of the coating sub-system 200B with about 15 μW/cm² at room temperature as well as at an elevated temperature of 100° C. showed gel formation within 75 minutes and at 60 minutes, respectively.

Table 1 summarizes results from a series of experiments used to test the effectiveness of various embodiments of a light-blocking device in reducing the intensity of stray light. The experiments were completed on a moving fiber using a draw system with a configuration similar to the one shown in FIG. 4. The actinic light source system 250 was a series of five Hg lamps (9 mm Fusion D bulbs) (Heraeus Noblelight America, LLC, I256/F10T, with reflector box) generating a total power of 375 W/inch along the length of the light source. The spacing between actinic light source 250 and the input end of the second coating sub-system 200B was approximately 27″ (27 inches). A detector was placed adjacent to the input location of the moving fiber into coating sub-system 200B to detect the intensity of stray light 252S. Table 1 shows the intensity of stray light 252S for various light-blocking devices 300. Each light-blocking device 300 surrounded the moving fiber. In Table 1, “ID” means inside diameter.

Example 1 is a control that excludes a light blocking device. The intensity of stray light at the input of the second coating sub-system was measured to be 90 μW/cm². Examples 2 and 3 use stainless steel tubes with shiny interior surfaces. In these examples, more stray light was incident to the input of the second coating sub-system than in the control example. In Example 4, a stainless steel tube with a shiny black interior surface was used and the intensity of stray light was reduced by more than 50%. Examples 5-12 show results for light-blocking devices consisting of tubes configured with various numbers and sizes of apertures. In each of Examples 5-12, the moving fiber passed through the aperture and significant reductions in the intensity of stray light at the input to the second coating sub-system were observed. Similar results were obtained in offline tests using LEDs operating at 395 nm as the light source.

TABLE 1

| | | Intensity |
|---|---|---|
| Example | Light-Blocking Device | (μW/cm²) |
| 1 | None (control) | 90 |
| 2 | 1.5″ ID shiny steel tube, 1 ft long | 240 |
| 3 | 1.0″ ID shiny steel tube, 1 ft long | 105 |
| 4 | 1.0″ ID black shiny tube, 1 ft long | 36 |
| 5 | 1″ ID threaded tube with 2 iris apertures: #1 | 3 |
| | aperture at 10 mm ID and #4 aperture at 10 | |
| | mm ID, 15″ long tube | |
| 6 | 1″ ID threaded tube with 2 iris apertures: #1 | <0.02 |
| | aperture at 0.8 mm ID and #4 aperture at 10 | |
| | mm ID, 15″ long tube | |
| 7 | 1″ ID threaded tube with 2 iris apertures: | 1 |
| | tube #1 aperture at 5 mm ID and #4 | |
| | aperture at 10 mm ID, 15″ long tube | |
| 8 | 1″ ID threaded tube with 4 iris apertures: #1- | 3 |
| | #4 apertures at 10 mm ID, 15″ long tube | |
| 9 | 1″ ID threaded tube with 4 iris apertures: #1 | 1 |
| | aperture at 5 mm ID and #2-#4 apertures at | |
| | 10 mm ID, 15″ long tube | |
| 10 | 1″ ID threaded tube with 4 iris apertures: #1 | 0.7 |
| | & #2 apertures at 5 mm ID and #3 & #4 | |
| | apertures at 10 mm ID, 15″ long tube | |
| 11 | 1″ ID threaded tube with 4 iris apertures: #1- | 0.5 |
| | #3 apertures at 5 mm ID and #4 aperture at | |
| | 10 mm ID, 15″ long tube | |
| 12 | 1″ ID threaded tube with 4 iris apertures: #1- | 0.5 |
| | #4 apertures at 5 mm ID, 15″ long tube | |

Aspect 1 of the description is:

A coating system for coating a moving optical fiber, comprising:

a first coating sub-system, the first coating sub-system configured to apply a first coating material to a moving optical fiber, the first coating sub-system comprising a source of actinic light configured to generate actinic light for curing the first coating material to form a first coating on the moving optical fiber, the source of actinic light further generating stray actinic light, the stray actinic light exiting the first coating sub-system;

a second coating sub-system containing a second coating material, the second coating sub-system configured to receive the moving optical fiber and to apply the second coating material to the first coating; and

a light-blocking device operably disposed between the first and second coating sub-systems, the light-blocking device configured to receive the moving optical fiber, the light-blocking device further configured to receive the stray actinic light exiting the first coating sub-system and to direct the stray actinic light to the second coating sub-system, the stray actinic light entering the light-blocking device at a first intensity, the first intensity sufficient to cause formation of a gel from the second coating material in the second coating sub-system within a first time period, the light-blocking device attenuating the stray actinic light such that (i) none of the stray actinic light is incident to the second coating sub-system or (ii) the stray actinic light exiting the light-blocking device is incident to the second coating sub-system at a second intensity, the second intensity insufficient to cause formation of a gel from the second coating material in the second coating sub-system within a second time period, the second time period being at least a factor of two longer than the first time period.

Aspect 2 of the description is:

The coating system according to Aspect 1, wherein the optical fiber is a bare optical fiber.

Aspect 3 of the description is:

The coating system according to Aspect 1 or 2, wherein the actinic light comprises ultraviolet light.

Aspect 4 of the description is:

The coating system according to any of Aspects 1-3, wherein the source of actinic light comprises a light emitting diode.

Aspect 5 of the description is:

The coating system according to any of Aspects 1-4, wherein the second coating sub-system comprises a coating die having a central channel having an input end, and wherein second intensity is insufficient to cause formation of a gel from the second coating material at the input end of the central channel within the second time period.

Aspect 6 of the description is:

The coating system according to any of Aspects 1-5, wherein the second coating sub-system further comprises a source of actinic light configured to generate actinic light for curing the second coating material to form a second coating on the first coating.

Aspect 7 of the description is:

The coating system according to any of Aspects 1-6, wherein the light-blocking device surrounds the moving optical fiber.

Aspect 8 of the description is:

The coating system according to any of Aspects 1-7, wherein the light-blocking device comprises at least one iris having an aperture through which the moving optical fiber passes.

Aspect 9 of the description is:

The coating system according to Aspect 8, wherein the aperture is adjustable.

Aspect 10 of the description is:

The coating system according to any of Aspects 1-9, wherein the light-blocking device comprises a light baffle comprising at least two spaced-apart aperture members, each of the aperture members comprising an aperture through which the moving optical fiber passes.

Aspect 11 of the description is:

The coating system according to Aspect 10, wherein the light baffle comprises at least four spaced-apart aperture members.

Aspect 12 of the description is:

The coating system according to Aspect 10 or 11, wherein the moving optical fiber entering the light-blocking device has a diameter DF and wherein each of the apertures has a diameter Da in the range (1.05)·DF≤Da≤(10)·DF.

Aspect 13 of the description is:

The coating system according to any of Aspects 10-12, wherein the light baffle comprises a tube having an interior surface, and wherein the interior surface comprises at least one of:
i) a material that substantially absorbs actinic light; and
ii) microstructure elements configured to reduce an amount of transmission of the stray actinic light that exits the light baffle.

Aspect 14 of the description is:

The coating system according to any of Aspects 1-13, wherein the second intensity is less than 25% of the first intensity.

Aspect 15 of the description is:

The coating system according to Aspect 14, wherein the second intensity is less than 10% of the first intensity.

Aspect 16 of the description is:

The coating system according to Aspect 14, wherein the second intensity is less than 1% of the first intensity.

Aspect 17 of the description is:

The coating system according to any of Aspects 14-16, wherein the first coating material comprises a first acrylate compound and the second coating material comprises a second acrylate compound.

Aspect 18 of the description is:

The coating system according to any of Aspects 1-17, wherein the second intensity is less than 40 μW/cm².

Aspect 19 of the description is:

The coating system according to any of Aspects 1-18, wherein the first intensity is greater than 90 μW/cm².

Aspect 20 of the description is:

The coating system according to any of Aspects 1-19, wherein the second intensity is less than 10 μW/cm².

Aspect 21 of the description is:

The coating system according to any of Aspects 1-19, wherein the second intensity is less than 2 μW/cm².

Aspect 22 of the description is:

The coating system according to any of Aspects 1-21, wherein the second time period is at least a factor of ten longer than the first time period.

Aspect 23 of the description is:

The coating system according to any of Aspects 1-21, wherein the second time period is at least a factor of 100 longer than the first time period.

Aspect 24 of the description is:

The coating system according to any of Aspects 1-23, further comprising:

a take-up section disposed downstream of the coating system and configured to take up and store the moving optical fiber.

Aspect 25 of the description is:

A method for coating a moving optical fiber, comprising:

directing a moving optical fiber into a first coating sub-system;

applying a first coating material to the moving optical fiber in the first coating sub-system;

curing the first coating material to form a first coating on the moving optical fiber; the curing comprising directing actinic light from a source of actinic light to the first coating material, the actinic light comprising actinic light for curing the first coating material and stray actinic light, the stray actinic light having an intensity, the stray actinic light exiting the first coating sub-system at a first intensity and propagating toward a second coating sub-system, the second coating sub-system containing a second coating material, the first intensity sufficient to cause formation of a gel from the second coating material in the second coating sub-system in a first time period;

reducing the intensity of the stray actinic light from the first intensity such that (i) none of the stray actinic light is incident to the second coating sub-system or (ii) the stray light is incident to the second coating sub-system at a second intensity, the second intensity insufficient to cause formation of a gel from the second coating material in the second coating sub-system in a second time period, the second time period being at least a factor of two longer than the first time period;

directing the moving optical fiber from the first coating sub-system to the second coating sub-system; and

applying the second coating material to the first coating in the second coating sub-system.

Aspect 26 of the description is:

The method according to Aspect 25, wherein the optical fiber is a bare optical fiber.

Aspect 27 of the description is:

The method according to Aspect 25 or 26, wherein the moving optical fiber is moving at a speed of at least 40 m/s.

Aspect 28 of the description is:

The method according to any of Aspects 25-27, wherein the first coating material comprises a first acrylate compound and the second coatings material comprises a second acrylate compound.

Aspect 29 of the description is:

The method according to any of Aspects 25-28, wherein the actinic light comprises ultraviolet light.

Aspect 30 of the description is:

The method according to any of Aspects 25-29, wherein the reducing intensity comprises propagation of the stray light exiting the first coating sub-system through a light-blocking device positioned between the first coating sub-system and the second coating sub-system, the light-blocking device comprising an aperture.

Aspect 31 of the description is:

The method according to Aspect 30, further comprising directing the moving optical fiber through the aperture of the light-blocking device.

Aspect 32 of the description is:

The method according to any of Aspects 25-31, wherein the second intensity is less than 10% of the first intensity.

Aspect 33 of the description is:

The method according to any of Aspects 25-32, wherein the second time period is at least a factor of 100 longer than the first time period.

Aspect 34 of the description is:

The method according to any of Aspects 25-33, further comprising curing the second coating material to form a second coating on the first coating.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A coating system for coating a moving optical fiber, comprising:
a first coating sub-system, the first coating sub-system configured to apply a first coating material to a moving optical fiber, the first coating sub-system comprising a source of actinic light configured to generate actinic light for curing the first coating material to form a first coating on the moving optical fiber, the source of actinic light further generating stray actinic light, the stray actinic light exiting the first coating sub-system;
a second coating sub-system containing a second coating material, the second coating sub-system configured to receive the moving optical fiber and to apply the second coating material to the first coating; and
a light-blocking device operably disposed between the first and second coating sub-systems, the light-blocking device configured to receive the moving optical fiber, the light-blocking device further configured to receive the stray actinic light exiting the first coating sub-system and to direct the stray actinic light to the second coating sub-system, the stray actinic light entering the light-blocking device at a first intensity, the first intensity sufficient to cause formation of a gel from the second coating material in the second coating sub-system within a first time period, the light-blocking device attenuating the stray actinic light such that (i) none of the stray actinic light is incident to the second coating sub-system or (ii) the stray actinic light exiting the light-blocking device is incident to the second coating sub-system at a second intensity, the second intensity insufficient to cause formation of a gel from the second coating material in the second coating sub-system within a second time period, the second time period being at least a factor of two longer than the first time period.

2. The coating system according to claim 1, wherein the source of actinic light comprises a light emitting diode.

3. The coating system according to claim 1, wherein the second coating sub-system comprises a coating die having a central channel having an input end, and wherein second intensity is insufficient to cause formation of a gel from the second coating material at the input end of the central channel within the second time period.

4. The coating system according to claim 1, wherein the second coating sub-system further comprises a source of actinic light configured to generate actinic light for curing the second coating material to form a second coating on the first coating.

5. The coating system according to claim 1, wherein the light-blocking device surrounds the moving optical fiber.

6. The coating system according to claim 1, wherein the light-blocking device comprises at least one iris having an aperture through which the moving optical fiber passes.

7. The coating system according to claim 1, wherein the light-blocking device comprises a light baffle comprising at least two spaced-apart aperture members, each of the aperture members comprising an aperture through which the moving optical fiber passes.

8. The coating system according to claim 7, wherein the moving optical fiber entering the light-blocking device has a diameter DF and wherein each of the apertures has a diameter Da in the range (1.05)·DF≤Da≤(10)·DF.

9. The coating system according to claim 7, wherein the light baffle comprises a tube having an interior surface, and wherein the interior surface comprises at least one of:
i) a material that substantially absorbs actinic light; and
ii) microstructure elements configured to reduce an amount of transmission of the stray actinic light that exits the light baffle.

10. The coating system according to claim 1, wherein the second intensity is less than 10% of the first intensity.

11. The coating system according to claim 1, wherein the first coating material comprises a first acrylate compound and the second coating material comprises a second acrylate compound.

12. The coating system according to claim 1, wherein the first intensity is greater than 90 μW/cm².

13. The coating system according to claim 1, wherein the second intensity is less than 10 μW/cm².

14. The coating system according to claim 1, wherein the second time period is at least a factor of ten longer than the first time period.

15. A method for coating a moving optical fiber, comprising:
directing a moving optical fiber into a first coating sub-system;
applying a first coating material to the moving optical fiber in the first coating sub-system;
curing the first coating material to form a first coating on the moving optical fiber; the curing comprising directing actinic light from a source of actinic light to the first coating material, the actinic light comprising actinic light for curing the first coating material and stray actinic light, the stray actinic light having an intensity, the stray actinic light exiting the first coating sub-system at a first intensity and propagating toward a second coating sub-system, the second coating sub-system containing a second coating material, the first intensity sufficient to cause formation of a gel from the second coating material in the second coating sub-system in a first time period;
reducing the intensity of the stray actinic light from the first intensity such that (i) none of the stray actinic light is incident to the second coating sub-system or (ii) the stray light is incident to the second coating sub-system at a second intensity, the second intensity insufficient to cause formation of a gel from the second coating material in the second coating sub-system in a second time period, the second time period being at least a factor of two longer than the first time period;
directing the moving optical fiber from the first coating sub-system to the second coating sub-system; and
applying the second coating material to the first coating in the second coating sub-system.

16. The method according to claim 15, wherein the moving optical fiber is moving at a speed of at least 40 m/s.

17. The method according to claim 15, wherein the first coating material comprises a first acrylate compound and the second coatings material comprises a second acrylate compound.

18. The method according to claim 15, wherein the reducing intensity comprises propagation of the stray light exiting the first coating sub-system through a light-blocking device positioned between the first coating sub-system and the second coating sub-system, the light-blocking device comprising an aperture.

19. The method according to claim 15, wherein the second intensity is less than 10% of the first intensity.

20. The method according to claim 15, wherein the second time period is at least a factor of 100 longer than the first time period.

21. The method according to claim 15, further comprising curing the second coating material to form a second coating on the first coating.
